(19) United States
(12) Patent Application Publication
(10) Pub. No.: US 2026/0236492 A1
(43) Pub. Date: Aug. 13, 2026

(54) ENHANCED INDEXING OF DIGITAL COMMUNICATIONS

(71) Applicant: Smarsh Inc., Portland, OR (US)

(72) Inventors: Gregory Breeze, Portland, OR (US); John Onusko, Portland, OR (US)

(21) Appl. No.: 19/464,421

(22) Filed: Jan. 29, 2026

Related U.S. Application Data
(60) Provisional application No. 63/756,520, filed on Feb. 10, 2025.

(51) Int. Cl. G06F 16/31; G06F 16/383

(52) U.S. Cl. CPC G06F 16/31; G06F 16/383

(57) ABSTRACT

Systems, methods, and apparatuses disclosed herein may manage digital communications by capturing, normalizing, enriching, and storing the digital communications as immutable records to improve compliance, searchability, and analytics. Communications may be received from diverse modalities and may be normalize them into a predefined data structure. Metadata enrichment processes enhance the communications by appending contextual information (e.g., including information associated with non-searchable content). The enriched communications may be stored in a write-once, read-many (WORM) data store to ensure immutability and compliance with regulatory standards. An indexing mechanism may organize the enriched metadata for efficient retrieval and analytics, supporting functionalities associated with regulatory audits or compliance monitoring.

### CROSS-REFERENCE TO RELATED APPLICATION

This application claims the benefit of, and priority to, U.S. Provisional Application No. 63/756,520, filed on Feb. 10, 2025, and entitled “ENHANCED INDEXING OF DIGITAL COMMUNICATIONS,” which is hereby incorporated by reference in its entirety.

### TECHNICAL FIELD

The present systems and processes relate to the field of digital communication management, and more particularly to systems and methods for enriching, indexing, and archiving digital communications with enhanced metadata for improved searchability, compliance, and analytics.

### BACKGROUND

Digital communication systems generate an immense volume of communications across various modalities, including emails, instant messages, voice recordings, video calls, and documents. Organizations increasingly rely on such communications for internal operations, regulatory compliance, and external interactions. These communications often include metadata—such as sender and recipient details, timestamps, and group affiliations—that can significantly enhance the organization’s ability to search, analyze, and manage communications.

However, existing systems for managing digital communications often fail to effectively capture, normalize, and enrich metadata associated with these communications. Many systems lack the capability to identify and integrate additional contextual metadata, such as whether the sender is internal or external, the language used in the communication, or any organizational directory-based information about participants. The absence of enriched metadata hampers an organization’s ability to accurately categorize communications, implement role-based access controls, and enforce retention policies.

Moreover, a significant challenge lies in maintaining compliance with stringent regulatory requirements. For example, certain regulations, such as those enforced by the U.S. Securities and Exchange Commission (SEC), require communications to be stored in an immutable format, preventing alteration or deletion while still allowing for enhanced indexing and metadata association. Existing systems often struggle to decouple metadata enrichment from the immutable storage of the original communication, thereby limiting flexibility in updating or correcting metadata after archival.

Another issue arises when processing communications with non-searchable content, such as scanned documents or voice recordings. Current systems may lack tools to extract and incorporate searchable text, further diminishing the utility of the archived data. Additionally, the inability to apply consistent enrichment and normalization to data from various modalities creates operational inefficiencies and increases the complexity of ensuring compliance and responding to discovery requests.

These deficiencies underscore the need for an improved approach to enriching, indexing, and archiving digital communications, particularly one that addresses the technical challenges of metadata enrichment, compliance with retention policies, and the processing of diverse communication formats.

### BRIEF SUMMARY OF THE DISCLOSURE

Briefly described, and according to one embodiment, aspects of the present disclosure generally relate to normalizing, enriching, and storing communications with enhanced metadata for improved compliance, searchability, and analytics. According to various aspects, a digital communication may be received from a communication modality, such as email, text messaging, voice recordings, or collaborative platforms. The digital communication may include communication content and/or communication metadata. Enriched metadata may be determined based on the communication content and/or the communication metadata. The enriched metadata may include contextual details derived from the communication content and communication metadata, such as sender and recipient information, timestamps, language, and organizational roles.

The digital communication may be normalized into a predefined data structure, ensuring that metadata fields are standardized for consistent processing and storage. During the enrichment process, metadata may be enhanced by performing operations such as identifying whether the sender is internal or external to an organization, determining the language of the communication, or associating custom attributes like confidentiality flags, priority levels, or retention policies. Non-searchable content, such as scanned documents or voice recordings, may be processed by utilizing optical character recognition (OCR) or transcription to determine searchable text that is associated with the enriched metadata.

The normalized communication and associated enriched metadata may be stored in a write-once, read-many (WORM) data store, ensuring the immutability of the original content in compliance with regulatory requirements. An index associated with the immutable data object may be generated to facilitate advanced search functionality, filtering, and/or tagging based on the enriched metadata. The index may be updated to reflect changes in directory data or metadata corrections without altering the original immutable content.

In addition to facilitating efficient storage and/or searchability, the disclosed systems and methods may provide support for compliance and/or analytics. Compliance-related metadata, such as legal hold tags, e-discovery labels, and audit readiness markers, may be associated with the digital communication. Analytics capabilities may include identifying communication patterns, analyzing frequency, and/or performing sentiment analysis based on the enriched metadata. Alerts may be generated for communications indicating potential policy violations or sensitive content. Moreover, aspects of the disclosure may address challenges associated with managing large volumes of communications across diverse modalities by providing a robust framework for metadata enrichment, compliance adherence, and efficient indexing and retrieval.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of a system for enhanced indexing of digital communications according to various aspects of the present disclosure;

FIG. 2 illustrates an example of a networked environment for the disclosed system according to various aspects of the present disclosure;

FIG. 3 illustrates an example of a process for receiving and normalizing digital communications according to various aspects of the present disclosure;

FIG. 4 illustrates an example of a process for storing normalized and enriched digital communications according to various aspects of the present disclosure;

FIG. 5 illustrates an example of a process for updating indexed metadata according to various aspects of the present disclosure;

FIG. 6 illustrates an example of a process for managing digital communications according to various aspects of the present disclosure;

FIG. 7 illustrates a schematic of an example of a computing device used in the enhanced indexing of digital communications; and

FIG. 8 illustrates an example diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

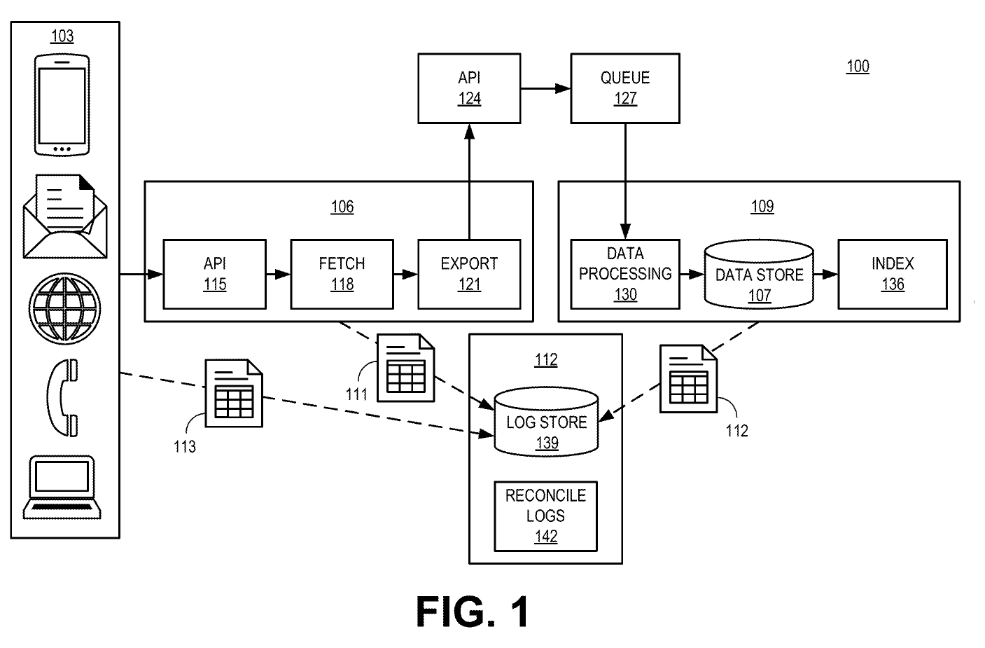

Referring now to the figures, for the purposes of example and explanation of the fundamental processes and components of the disclosed systems and processes, reference is made to FIG. 1, which illustrates an example of a system 100 for enhanced indexing of data objects (e.g., digital communications). The system 100 may capture data objects from multiple communication modalities 103, normalize the data objects into a predefined data structure, and/or enrich the data objects with additional metadata using the capture process 106. The system 100 may store the normalized and enriched data objects in a write-once, read-many (WORM) data store 107 as immutable data objects using the archive process 109. The data store 107 may include write once, read many (“WORM”) storage. For example, once the data object has been archived in the data store 107, the data object may not be modified or deleted. According to some aspects, the data store 107 may utilize a distributed blockchain ledger to prevent modification or deletion of the stored data object.

The capture process 106 and the archive process 109 may generate log entries 111 and 112. In some aspects, the log entries 111, 112 may represent the digital communications received at the capture process 106 and/or the archive process 109. In some other aspects, the log entries may represent the digital communications that have completed the capture process 106 and/or the archive process 109. In some other embodiments, the system 100 may request and receive log entries 113 from the communication modalities 103 representing the digital communications generated by the communication modalities 103.

The communication modalities 103 may generate data objects associated with a wide variety of digital communications. For example, the data objects may include communication content, such as emails, text messages, direct messages, audio and video calls, conversation threads, attachments, and shared documents. Moreover, the data objects may include communication metadata, which may include contextual information, such as sender and recipient details, timestamps, subject lines, file types, and content categories. The system 100 may receive the data objects from the communication modalities 103 using the capture process 106.

As used herein, “capture” may refer to the system 100 obtaining data objects from the communication modalities 103 in real-time or near real-time without interrupting or delaying the transmission of the communication to its intended recipient. For example, if the data object is an email, the system 100 may capture the email as it is sent or received, ensuring that the original communication flow remains unaffected. The capture process 106 may maintain seamless integration with existing communication workflows, thereby avoiding any additional steps by the sender or recipient.

The system 100 may interface with the communication modalities 103 through application programming interfaces (APIs), webhook integrations, and/or other connectivity protocols. The system 100 may use the APIs to retrieve the data objects and any associated metadata directly, minimizing reliance on intermediate systems. Moreover, the capture process 106 may ensure that large volumes of data objects from multiple communication modalities may be processed efficiently without introducing delays or errors.

The capture process 106 may include one or more operations, such as an API call 115, metadata fetching 118, and/or exporting 121. The API call 115 may facilitate the receipt of data objects from the communication modalities 103. In some aspects, the system 100 may normalize the received data objects into a predefined data structure, e.g., with consistent fields and formatting. The normalization may ensure that data objects from disparate communication modalities, such as text messages and video calls, are standardized for subsequent processing and storage. For example, a text message may be normalized to include fields for the sender’s phone number, the timestamp, and/or the message content. In another example, a video call may include fields for participant names, call duration, and/or call transcript data.

The metadata fetching operation 118 may enrich the normalized data objects by associating them with additional metadata derived from external or internal data sources. For example, if the data object represents a text message, the system 100 may fetch and associate location information based on an area code associated with the text message. If the data object is an email, the system 100 may retrieve an organizational role or group affiliation associated with a sender of the email by searching an organizational directory for information associated with the sender. The system 100 may then append the organizational role or group affiliation associated with the sender to the additional metadata. Moreover, metadata fetching 118 may also include identifying the language of the communication, tagging sensitive content, or applying predefined retention or confidentiality policies.

Once the data object has been normalized and enriched, the exporting operation 121 may transmit the data object to an internal queue 127 for further processing. The API call 124 may place the enriched data objects in the queue 127 until the system 100 initiates the archive process 109. This queuing mechanism may allow the system 100 to manage processing workloads effectively, ensuring that incoming data objects are archived and indexed in a timely manner.

These steps in the capture process 106 may address the multifaceted challenges associated with managing digital communications from diverse modalities by providing a robust framework for data ingestion, transformation, and/or enhancement. The normalization process may ensure that communication content and metadata are converted into a consistent, predefined structure, enabling the system 100 to process data objects from varied sources (e.g., emails, text messages, voice recordings, and/or video calls) without introducing inconsistencies or errors. The enrichment process may further enhance the utility of the data objects by associating them with additional contextual metadata, such as sender roles, group affiliations, language identifiers, and geolocation information, thereby enabling more effective categorization, searchability, and/or compliance analysis. Seamless integration with communication modalities 103 ensures that the capture process operates in parallel with existing workflows, avoiding any disruptions to the normal transmission or receipt of communications. Moreover, the system 100 may handle large volumes of data in real-time or near real-time, ensuring reliable and efficient processing even in high-throughput environments. Thereby the system 100 may preserve the integrity of the original communications while enriching their usability, addressing critical operational and regulatory challenges faced by organizations managing complex and voluminous digital communication ecosystems.

The archive process 109 may include one or more operations, such as data processing 130, archiving in the data store 107, and/or indexing 136 of the archived data objects. During data processing 130, the system 100 may extract attachments, shared documents, and/or other embedded elements from the communication content. For example, if a data object represents an email containing an attachment, the data processing 130 may extract the attachment to ensure that it is archived and indexed both individually and in association with the original data object representing the email. Thereby both the email and its attachment may be retrieved and analyzed independently or together as needed for compliance or operational purposes.

According to some aspects, the data processing 130 may determine a state associated with a data object, such as its completeness or validity, before archival. Additionally, data processing 130 may identify associations between data objects generated by different communication modalities 103. For example, a conversation may begin in one modality, such as instant messaging, and continue in another, such as a video call. The system 100 may recognize the relationships and create metadata to associate the related data objects, facilitating unified analysis and retrieval across modalities. The associations may be stored as enriched metadata either as part of or separate from the data object.

Once processed, the data objects may be archived in the data store 107. The data store 107 may employ WORM storage, ensuring the immutability of the archived data objects. According to some aspects, once a data object has been archived, it cannot be modified or deleted, thereby meeting stringent regulatory requirements, such as those imposed by the U.S. Securities and Exchange Commission (SEC). The immutable nature of the data objects may provide reliability as records for compliance, legal, or operational purposes. For example, the data objects may be stored in a distributed blockchain ledger to prevent any modification or deletion and/or enhance traceability.

The archived data objects may be indexed 136 to enable efficient search and retrieval. Indexing 136 may include tagging the data objects with the enriched metadata, such as keywords, timestamps, sender and recipient details, file types, and/or the originating communication modality. For example, a video call data object may be indexed using participant names, call duration, and/or extracted transcript data. In another example, an email may be indexed using its subject line, sender and recipient information, and/or any attachments. The indexing process may ensure that the archived data objects are easily searchable and retrievable based on various metadata fields or combinations thereof.

The indexed data objects may be utilized to fulfill compliance requirements or discovery requests. For example, the system 100 may perform targeted searches of the archived data objects in response to regulatory audits, legal holds, or e-discovery requests, ensuring that relevant communications are readily accessible. This combination of data processing, archiving, and indexing within the archive process 109 may further address the challenges of managing and preserving large volumes of digital communications while ensuring compliance and operational efficiency.

The reconciliation process 114 may include receiving log entries 111, 112, and 113 at the log store 139 and reconciling the logs 142 to ensure the integrity and completeness of the data objects processed through the system 100. The log entries 111 and 112 may correspond to digital communications processed during the capture process 106 and the archive process 109, respectively, while the log entries 113 may represent communications generated by the communication modalities 103 but not yet processed by the system 100. By comparing these logs, the reconciliation process 114 may identify discrepancies, such as data objects that were generated by the communication modalities 103 but were not captured or archived by the system 100.

For example, reconciling the logs 142 may include analyzing a total number of entries in each log to detect any mismatches. Specific fields within the log entries, such as unique identifiers, timestamps, sender information, or file types, may be compared to identify data objects that did not complete a particular processing stage. If a log entry 113 indicates that a specific data object was generated but is absent in log entry 111, the system 100 may infer that the data object failed to complete the capture process 106. Similarly, if the data object is present in log entry 111 but not in log entry 112, the system 100 may determine that the data object did not proceed to the archive process 109 and, therefore, was not stored in the data store 107.

According to some aspects, the reconciliation process 114 may include generating alerts or reports to notify system administrators of any identified gaps or anomalies. The notifications may help ensure timely resolution of issues, such as reinitiating the capture process 106 and/or the archive process 109 for the missing data objects. Furthermore, the reconciliation process 114 may enhance compliance by verifying that all required communications have been successfully processed and archived in accordance with organizational policies and regulatory requirements. By leveraging the logs 142 to provide a comprehensive audit trail, the system 100 may provide transparency and accountability across all stages of data object management.

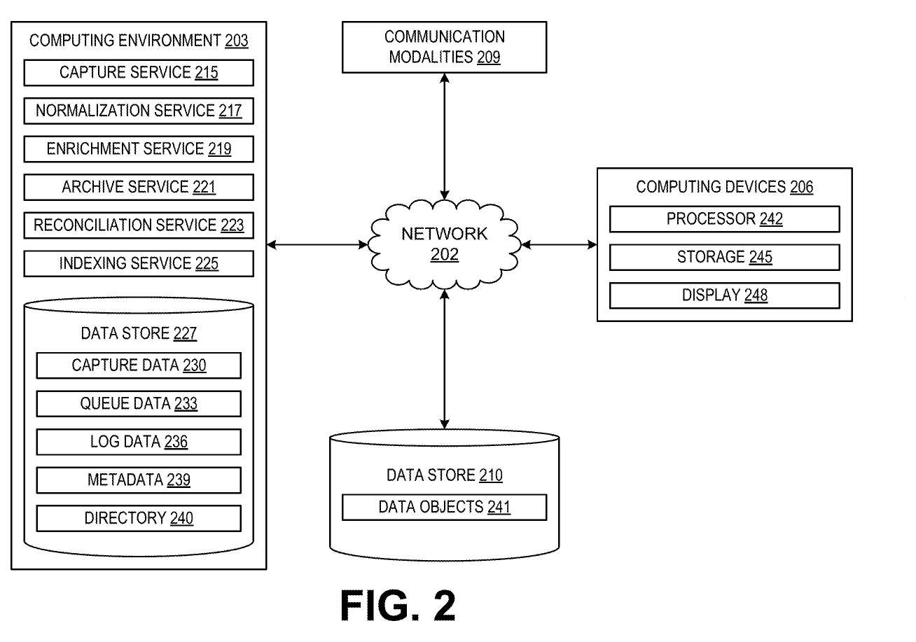

Referring now to FIG. 2, shown is an exemplary networked environment 200 for the system 100 according to various aspects of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, a computing environment 203 connected to one or more computing devices 206, one or more communication modalities 209, and the data store 210 over a network 212.

The elements of the computing environment 203 may be provided via one or more computing devices that may be arranged, for example, in one or more server banks or computer banks or other arrangements. Moreover, the one or more computing devices may be arranged in distributed, centralized, and/or cloud-based configurations. Such computing devices can be located in a single installation or may be distributed among many different geographical locations. For example, the computing environment 203 can include one or more computing devices that together may include a hosted computing resource, a grid computing resource, or any other distributed computing arrangement. In some cases, the computing environment 203 can correspond to an elastic computing resource where the allotted capacity of processing, network, storage, or other computing-related resources may vary over time. The computing environment 203 may include one or more processors and memory having instructions stored thereon that, when executed by the one or more processors, cause the computing environment 203 to perform one, some, or all of the actions, methods, steps, or functionalities provided herein.

The computing environment 203 may include a capture service 215, an enrichment a normalization service 217, an enrichment service 219, an archive service 221, a reconciliation service 223, and/or an indexing service 225. The capture service 215, the normalization service 217, the enrichment service 219, the archive service 221, the reconciliation service 223, and/or the indexing service 225 may correspond to one or more software executables that may be executed by the computing environment 203 to perform the functionality described herein. While the capture service 215, the normalization service 217, the enrichment service 219, the archive service 221, the reconciliation service 223, and the indexing service 225 are described as different services, it may be appreciated that the functionality of these services may be implemented in one or more different services executed in the computing environment 203. Various data may be stored in the data store 227, including but not limited to, the capture data 230, the queue data 233, the log data 236, the metadata 239, and/or the directory 240.

The capture service 215 may perform the capture process 106 to acquire and prepare data objects for subsequent processing networked environment 200. This capture process 106 may include receiving data objects from the communication modalities 209 through various methods, such as API calls (e.g., API call 115), webhook triggers, or other connectivity protocols. The capture service 215 may integrate with communication modalities 209, providing real-time or near real-time ingestion of data objects without interrupting or delaying the transmission of communications to their intended recipients. Moreover, the capture service 215 may utilize metadata fetching operations (e.g., metadata fetching 118) to enrich the data objects with contextual information. The metadata may include, but is not limited to, organizational roles, location details, language identifiers, and/or retention policies derived from internal or external sources such as directories, databases, or third-party APIs. The capture service 215 may also perform exporting operations (e.g., exporting 121) to queue enriched and normalized data objects for processing by one or more other services (e.g., the normalization service 217, the enrichment service 219, the archive service 221, the reconciliation service 223, and the indexing service 225). By maintaining a robust, scalable, and efficient data ingestion pipeline, the capture service 215 may ensure that diverse digital communications from various modalities are accurately captured, enriched, and prepared for further processes.

The normalization service 217 may standardize the data objects (e.g., captured by the capture service 215) into a predefined data structure. The normalization service 217 may provide uniformity across disparate data formats, such as text messages, video calls, and/or emails, thereby enabling consistent processing and downstream operations. The predefined data structure may include a plurality of fields, such as sender information, timestamp, content type, and/or metadata. For example, a video call with associated participant details, a text message containing geolocation data, or an email with attachments may be transformed into a common structure that aligns with one or more processing requirements.

In addition to standardizing the structural elements, the normalization service 217 may resolve discrepancies or inconsistencies in data representation. For example, data objects generated by different communication modalities may utilize varied encoding schemes, data types, or metadata formats, which may lead to inefficiencies or errors during processing. The normalization service 217 may address the challenges associated with the varied encoding schemes, data types, or metadata formats by converting the data elements into standardized formats, thereby ensuring that all metadata fields are populated with consistent and reliable information. Moreover, converting the data elements may include resolving character encoding mismatches (e.g., UTF-8 vs. ASCII), resolving differences in timestamp formats (e.g., UTC vs. local time), and/or reconciling data types for numerical, text, or binary fields.

The normalization process may also select or adapt the predefined data structure to enhance the contextual relevance and usability of the data objects. For example, the normalization service 217 may augment the predefined data structure with additional fields derived from the incoming data objects. The additional fields may include communication metadata, such as priority levels, language identifiers, confidentiality markers, or organizational affiliations. The additional fields may provide placeholders for contextual enhancements to improve the ability of the system to index, search, and retrieve archived data objects, supporting both operational efficiency and compliance requirements. For example, if an incoming email includes information about a recipient’s department within an organization, the normalization service 217 may create a corresponding field within the predefined structure to reflect this information.

Moreover, the normalization service 217 may operate in conjunction with other components of the computing environment 203 to streamline the overall data processing pipeline. By standardizing the input data objects, the normalization service 217 enables seamless integration with the enrichment service 219 and the indexing service 225. This integration allows the enriched metadata generated by the enrichment service 219 to be effectively appended to the normalized data objects, further enhancing their utility for compliance, analytics, and operational purposes. Moreover, the uniform structure provided by the normalization service 217 may ensure that the indexing service 225 can create comprehensive and accurate indices for efficient data retrieval.

The enrichment service 219 may enhance normalized data objects by integrating additional metadata from a variety of internal and external sources. Moreover, the enrichment service 219 may access organizational directories, geographic databases, or external APIs to obtain supplemental information associated with the data objects. For example, if the data object represents an email, the enrichment service 219 may determine the organizational roles of the sender and recipient by cross-referencing the organization’s directory. Furthermore, the enrichment service 219 may derive geographic locations from IP addresses, time zones from timestamps, or file type classifications from the content of attachments. By appending the enriched metadata to the data objects, the system 100 may provide enhanced searchability, improve analytics capabilities, and adhere more effectively to compliance requirements.

To further augment the utility of the data objects, the enrichment service 219 may incorporate advanced processing techniques for non-searchable content. For example, optical character recognition (OCR) may be applied to scanned documents. The OCR may convert image-based text into machine-readable and searchable formats. Moreover, transcription services may process audio or video files to generate searchable text, such as transcripts of voice calls or video conference discussions. The enrichment service 219 may make non-textual data searchable and/or may enable the inclusion of contextual information, such as speaker identification, timestamps within the audio or video, and sentiment analysis. Such metadata may facilitate compliance audits, discovery processes, and operational analyses by ensuring that all data objects are both searchable and richly annotated.

According to some aspects, the enrichment service 219 may apply classification and tagging mechanisms to the data objects, enabling more sophisticated organizational and analytical workflows. For example, the enrichment service 219 may categorize data objects based on predefined rules, such as tagging sensitive content with confidentiality labels, identifying records subject to specific retention policies, and/or flagging potential policy violations. This categorization may be performed using one or more machine learning algorithms. The machine learning algorithms may analyze patterns in the data objects and assign appropriate tags based on organizational policies or industry standards. Moreover, the enrichment service 219 may enrich metadata by adding semantic relationships, such as associating email threads with related calendar events or linking text messages to corresponding shared documents, thereby providing a more holistic view of the communication context.

By operating in close coordination with the normalization service 217 and the indexing service 225, the enrichment service 219 may streamline the end-to-end processing pipeline. Moreover, by enriching the normalized data objects with contextual metadata, the enrichment service 219 may enable the indexing service 225 to create detailed indices that reflect both the original content and the added contextual information. These indices may include keywords, timestamps, sender and recipient roles, and other metadata, ensuring that data objects are efficiently searchable and retrievable. Furthermore, the enrichment service 219 may update metadata dynamically to reflect changes in organizational directories or compliance requirements, maintaining the relevance and accuracy of the enriched data objects throughout their lifecycle.

The archive service 221 may manage secure and efficient storage of normalized and enriched data objects, ensuring compliance with stringent regulatory requirements. The archive service 221 may use a queue mechanism to manage the flow of data objects temporarily as queue data 233. The queuing process may accommodate varying volumes of incoming data objects, facilitating load balancing and preventing bottlenecks during peak data ingestion periods. Thereby the archive service 221 may ensure that all incoming data objects are appropriately sequenced and prepared for archival without impacting system performance or data integrity.

After the temporary queuing stage, the archive service 221 may transfer data objects to the data store 210 for permanent archival as immutable data objects 241. The data store 210 may employ WORM storage, which may prohibit modification or deletion of archived data objects, ensuring their immutability. This immutability may be required to satisfy compliance standards, such as those imposed by the U.S. Securities and Exchange Commission (SEC) or the General Data Protection Regulation (GDPR), e.g., mandating that certain types of communication records remain unaltered. Additionally, the WORM storage configuration may ensure reliability and/or integrity of archived records, thereby providing an auditable trail for regulatory and legal purposes. According to some aspects, the data store 210 may utilize a distributed blockchain ledger to prevent modification or deletion of the stored data object.

The archive service 221 may include data processing functionalities to enhance the archival process. For example, during archival, the archive service 221 may extract metadata such as keywords, timestamps, or sender and recipient details from the normalized and enriched data objects. The metadata elements may then be appended to the corresponding immutable records to facilitate advanced indexing and retrieval. Furthermore, the archive service 221 may implement retention policies, ensuring that archived records are stored for predefined durations aligned with organizational or regulatory requirements. Upon the expiration of the retention period, one or more alerts may be generated for authorized personnel, enabling controlled and compliant data disposal processes. By integrating these functionalities, the archive service 221 may provide secure and compliant storage of data objects, facilitating seamless retrieval and utilization for compliance audits, discovery requests, and/or operational analyses.

The indexing service 225 may enable the creation of a robust directory 240 that organizes archived data objects by associating them with comprehensive metadata tags. The metadata tags may be derived from normalized and enriched metadata, ensuring that the indexed data objects are both searchable and contextually meaningful. For example, each data object may be tagged with key attributes such as sender/recipient details, timestamps, file types, and/or content classifications. By building an organized and detailed directory, the indexing service 225 may facilitate efficient retrieval of data objects, enabling users to perform complex search queries and filtering operations with minimal latency.

In some aspects, the indexing service 225 may utilize one or more indexing algorithms to enhance the granularity and precision of search capabilities. For example, the indexing service 225 may prioritize frequently accessed metadata fields, such as keywords or timestamps, to optimize the search and filtering process. Moreover, the indexing service 225 may incorporate hierarchical tagging structures, allowing users to navigate relationships between data objects, such as email threads, attachments, or related communications across multiple modalities. For example, a video call indexed with participant details and transcript keywords may be linked to follow-up email discussions, providing a comprehensive view of related interactions.

According to some aspects, the indexing service 225 may implement dynamic indexing mechanisms that account for changes in metadata or organizational requirements. For example, updates to an organizational directory may prompt the indexing service 225 to update tags associated with sender roles or group affiliations, ensuring that the indexed metadata remains accurate and relevant. The dynamic updates may occur without altering the original immutable data objects, preserving their integrity while maintaining the utility of the directory for compliance audits, e-discovery requests, and operational analyses.

According to some aspects, the indexing service 225 may support advanced analytical features by integrating metadata-driven insights into the retrieval process. For example, the indexing service 225 may identify communication patterns, such as high-frequency interactions between specific departments or regions, by analyzing indexed timestamps and sender/recipient information. Additionally, the inclusion of sentiment analysis tags derived from enriched metadata may enable users to filter and analyze communications based on emotional tone, further enhancing the operational and compliance value of the indexed directory. By providing these advanced functionalities, the indexing service 225 may ensure that archived data objects are securely stored and are readily accessible and actionable for various organizational needs.

The data store 227 may serve as a central repository for various types of data generated or processed by the computing environment 203. This data may include capture data 230 associated with the capture service 215, which may represent raw or minimally processed data objects received from communication modalities 209. The capture data 230 may include content, metadata, or attachments that have been ingested but not yet normalized or enriched. For example, an email’s subject line, sender/recipient details, and timestamp may be stored in the capture data 230 prior to normalization or enrichment processes.

Queue data 233 may store intermediate data objects that have undergone partial processing, such as normalization, and are awaiting subsequent operations like enrichment or archival. By leveraging queue data 233, the system may implement load-balancing strategies to manage varying data volumes and ensure efficient processing during peak loads. For example, queue data 233 may include normalized email metadata, such as content type and organizational roles, which may be enriched with contextual details during subsequent processing by the enrichment service 219.

Log data 236 may represent detailed audit trails associated with the operations performed on data objects within the system 100. The log data 236 may include records of data capture, normalization, enrichment, and/or archival, providing a comprehensive record of system operations. Log data 236 may also store details such as unique identifiers, timestamps, and/or processing statuses of data objects, enabling reconciliation processes performed by the reconciliation service 223. For example, a log entry may document the successful archival of an enriched video call transcript along with its associated metadata.

Metadata 239 (e.g., generated by the normalization service 217 and/or the enrichment service 219) may include both structured and unstructured data that enhances the usability and relevance of data objects. The metadata may include enriched details such as geographic locations, organizational roles, and timestamps. For example, metadata 239 may associate an email thread with its corresponding calendar event and attachments.

The directory 240 (e.g., generated by the indexing service 225) may organize data objects using hierarchical tagging mechanisms that support efficient retrieval and complex query operations. This directory may link metadata such as keywords, sender/recipient details, and content classifications to the corresponding immutable data objects, providing an organized structure for compliance audits, e-discovery requests, and operational analyses.

The reconciliation service 223 may validate data integrity by analyzing log entries generated at various stages of data processing, including capture, normalization, enrichment, archival, and/or indexing. The log entries may be stored in a log store and may include unique identifiers, timestamps, and processing statuses for each data object, enabling a comprehensive audit trail. By comparing the captured log entries against those generated in subsequent processing stages, the reconciliation service 223 may identify discrepancies such as unprocessed or partially processed data objects. For example, the reconciliation service 223 may detect missing data objects that were captured but not archived or indexed, enabling swift diagnosis of system faults or workflow interruptions.

To address detected discrepancies, the reconciliation service 223 may initiate remedial actions such as re-processing affected data objects. For example, if a data object is missing from the archive log but present in the capture log, the reconciliation service 223 may trigger the archival process for that specific object. Similarly, discrepancies in enriched metadata or normalization fields may prompt re-execution of these processes, ensuring data completeness and consistency. The reconciliation service 223 may also generate real-time alerts to notify system administrators of critical issues, thereby facilitating rapid resolution of anomalies that may impact compliance or operational workflows.

According to some aspects, the reconciliation service 223 may enhance compliance by verifying that all data objects meet organizational policies and regulatory requirements. For example, the reconciliation service 223 may cross-reference log entries with retention policies to ensure all required communications have been archived as immutable data objects within their specified timeframes. Any deviations, such as premature deletion or extended retention, may result in system-generated compliance alerts or corrective actions. By implementing these checks, the reconciliation service 223 may uphold the reliability of the system as an auditable repository for regulatory and operational needs.

Moreover, the reconciliation service 223 may support analytical insights by aggregating and summarizing log data 236 for trend analysis and system optimization. For example, patterns in processing delays or error rates may be identified and addressed to enhance efficiency. The insights may inform resource allocation, such as optimizing server capacity during peak data ingestion periods. By providing both diagnostic and proactive functionalities, the reconciliation service 223 may maintain the integrity, compliance, and operational excellence of the disclosed system.

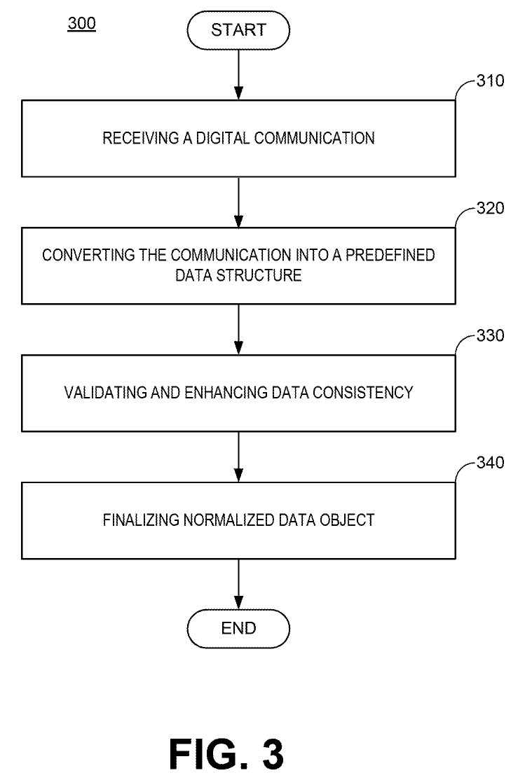

FIG. 3 illustrates an example of a process 300 for normalizing digital communications, addressing the technical challenges associated with managing heterogeneous data formats and ensuring consistency across diverse communication modalities. The normalization process 300 may standardize communication content and metadata into a predefined data structure, enabling seamless integration with downstream processing stages such as enrichment, archival, and indexing. By leveraging robust validation techniques and automated transformations, the process 300 may enhance the usability, accuracy, and compliance of the digital communications. Each step of process 300 may address one or more specific issues, such as discrepancies in encoding, missing metadata, or inconsistent formats, thereby providing a comprehensive solution to managing and preparing digital communications for advanced analytics, searchability, and compliance adherence.

At step 310, a digital communication (e.g., an email, text message, or video call data object) may be received from a communication modality. The communication modality may include various sources, such as collaborative platforms, email servers, or instant messaging systems. Step 310 may use one or more application programming interfaces (APIs) or webhook integrations to acquire the communication content and associated metadata in real-time or near real-time. Moreover, the process 300 may ensure that the original flow of communication is not interrupted or delayed.

For example, in the context of an email, the process 300 may extract details such as the subject line, sender and recipient information, timestamps, and attachments. Similarly, for a text message, the process 300 may acquire the phone number of the sender, geolocation metadata, and the message content. The capability to handle diverse communication formats from multiple sources may allow for seamless integration into existing workflows, addressing the technical challenge of managing heterogeneous data sources in a unified manner.

At step 320, the digital communication received in step 310 may be converted into a predefined data structure. Step 320 may standardize disparate formats and metadata fields to ensure consistency across data objects originating from different modalities. The predefined data structure may include standardized fields such as sender name, recipient identifiers, message body, timestamp, and metadata.

For example, an instant message containing a timestamp in local time may be converted into Coordinated Universal Time (UTC) to align with system-wide consistency. Additionally, binary attachments in an email, such as PDF documents, may be tagged with metadata fields such as file type and size. Moreover, step 320 may resolve discrepancies in encoding formats, such as converting text from ASCII to UTF-8, ensuring compatibility for downstream processes. By providing a unified structure, process 300 may address challenges in enabling consistent processing, searching, and/or retrieval of communication data across diverse formats.

At step 330, the process 300 may validate the normalized data structure to ensure completeness and correctness. Validation checks may include confirming the presence of required fields (e.g., sender information or timestamps) and/or verifying data integrity. If inconsistencies or missing fields are detected, remedial actions such as metadata fetching or reprocessing of raw data may be initiated.

For example, if a normalized email lacks organizational metadata, the process 300 may query an internal directory to append the sender’s department or role within the organization, thereby ensuring that all normalized data objects meet predefined quality standards and are enriched with additional contextual information where necessary. By enhancing data consistency, step 330 of process 300 may support the seamless transition of data objects to subsequent processing stages, addressing operational inefficiencies caused by incomplete or inconsistent data.

At step 340, the process 300 may finalize the validated and normalized data object and prepare it for subsequent processes such as enrichment or archival. Moreover, step 340 may include assigning unique identifiers to the data objects, enabling precise tracking across the system. Additionally, finalized data objects may be temporarily stored in a queue or forwarded to enrichment services for further processing.

For example, a normalized video call may include participant details, call duration, and a transcript placeholder, making it ready for additional metadata enrichment, such as speaker identification or sentiment analysis. By finalizing the normalized data object, step 340 may ensure that the system maintains a robust pipeline for managing large volumes of digital communications efficiently, providing a scalable solution for organizations facing diverse and complex communication data challenges.

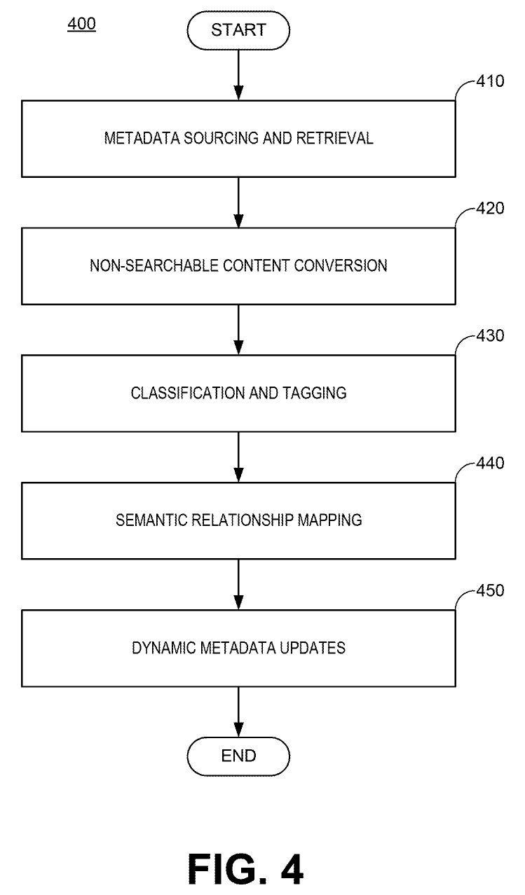

According to some aspects, FIG. 4 illustrates a process 400 for enriching metadata associated with digital communications (e.g., data objects) to address challenges in searchability, compliance, and analytics. For example, the process may augment normalized data objects with additional metadata derived from internal and external data sources. The enrichment of the metadata may ensure that the digital communications are contextually relevant, searchable, and aligned with organizational and regulatory requirements.

At step 410, the process 400 may retrieve supplementary metadata from internal and/or external sources to enhance the normalized data objects. Internal sources may include organizational directories, customer relationship management (CRM) systems, and/or compliance databases. External sources may include APIs, public databases, and/or geographic information systems. According to some aspects, the process 400 may utilize one or more identifiers or fields within the normalized data, such as email addresses or IP addresses, to query the interval and/or external sources and extract relevant contextual information.

For example, if a normalized email contains an email address associated with the sender, step 410 may query an organizational directory to determine a role, department, and/or group affiliation associated with the email address. Moreover, for a text message containing a geolocation tag, the process 400 may utilize a geographic database to identify a city or country corresponding to the geolocation tag. By aggregating metadata from disparate sources, process 400 may enhance contextual relevance, further facilitating downstream analytics and compliance.

At step 420, the process 400 may convert non-searchable content, such as scanned documents or audio files, into machine-readable formats using Optical Character Recognition (OCR) and/or audio transcription services, thereby ensuring that all communication content is searchable and enriched with metadata derived from the conversion process. For example, OCR may extract text from a scanned PDF, such as an invoice or contract, and append the extracted text as metadata fields. Moreover, transcription services may process an audio recording from a video call to generate a text transcript, e.g., including speaker identification and timestamps. These metadata enhancements may enable the process 400 to address technical challenges in managing non-textual data, ensuring that all communications are actionable for compliance audits and operational analysis.

At step 430, the process 400 may apply classification and tagging mechanisms to the enriched metadata, enabling advanced categorization and organizational workflows. Classification may be performed using predefined rules or machine learning algorithms to assign tags that reflect the content’s sensitivity, priority, and/or retention policies. According to some aspects, tags may indicate compliance-related attributes, such as legal hold requirements or confidentiality levels. For example, an email containing sensitive customer data may be tagged with a confidentiality label based on predefined organizational policies. Moreover, machine learning models may analyze patterns in a dataset to flag potential policy violations or identify records requiring extended retention. By integrating classification and tagging, the system may improve its ability to effectively filter, sort, and analyze data objects, thereby addressing operational inefficiencies and regulatory compliance challenges.

At step 440, the process 400 may establish semantic relationships among data objects by linking related communications, such as email threads, shared documents, and corresponding calendar events. Moreover, the process 400 may use enriched metadata to create associations that provide a holistic view of communication contexts. For example, an email thread discussing a project milestone may be linked to a follow-up meeting invitation and shared documents in a collaborative workspace. The associations may be stored as metadata, enabling users to navigate between related data objects efficiently. This semantic mapping may enhance data retrieval and/or support compliance by maintaining traceable relationships across communication records, providing a comprehensive audit trail.

At step 450, the process 400 may perform dynamic updates to the enriched metadata to ensure its continued relevance and accuracy. Updates may occur in response to changes in organizational structures, policies, or external databases. Moreover, the process 400 may perform periodic queries to detect changes and refresh the metadata fields without modifying the immutable content of the original data objects. For example, if an employee’s role within an organization changes, the process 400 may update all relevant metadata fields in the associated records to reflect the new role. By dynamically managing metadata updates, the process 400 may ensure that the enriched data remains accurate and actionable over time, addressing long-term compliance and operational needs.

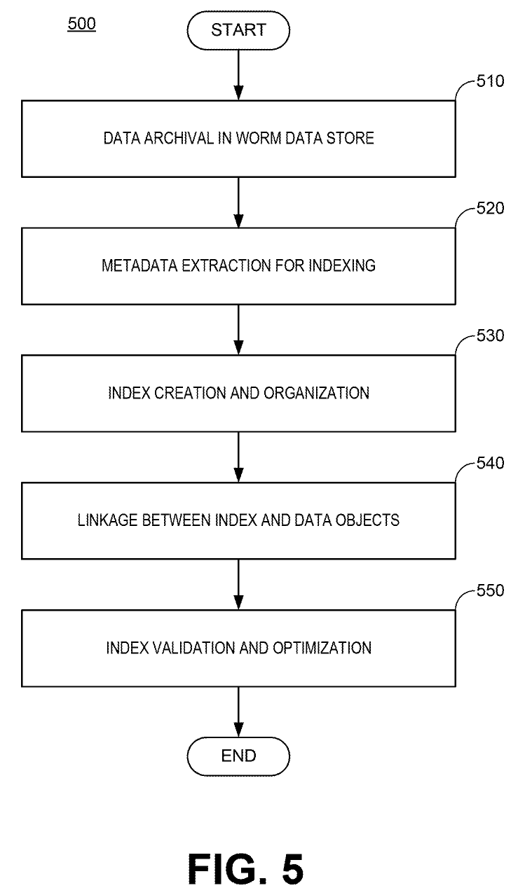

According to some aspects, FIG. 5 illustrates a process 500 for storing normalized and enriched digital communications as immutable data objects in a WORM data store. Moreover, the process 500 may generate an index associated with the immutable data objects to facilitate advanced searchability and retrieval based on the enriched metadata.

At step 510, the process 500 may transfer the normalized and enriched digital communication to a WORM data store. The WORM data store may maintain the immutability of the stored data objects, ensuring that no alterations or deletions can occur post-archival. This immutability may be beneficial for meeting stringent regulatory requirements, such as those mandated by the U.S. Securities and Exchange Commission (SEC) or General Data Protection Regulation (GDPR), which require unaltered and reliable storage of communications. For example, an enriched email containing metadata such as timestamps, sender/recipient roles, and/or confidentiality tags may be archived in the WORM data store as an immutable record. Moreover, process 500 may generate a cryptographic hash to validate the integrity of the data object upon retrieval. By leveraging WORM technology, step 510 may address the technical challenge of securely storing sensitive communications while adhering to regulatory compliance and preventing tampering.

At step 520, the process 500 may extract enriched metadata from the stored digital communication to facilitate the creation of a comprehensive index. The extracted metadata may include attributes such as sender/recipient details, timestamps, content classifications, and/or keywords derived from non-textual content (e.g., OCR-transcribed data or audio transcripts). For example, a video call archived in the WORM data store may be associated with metadata fields including participant names, call duration, and/or keywords from the conversation transcript. The metadata may be extracted systematically, ensuring alignment with predefined fields used for indexing. By creating a consistent and well-structured metadata set, the process 500 may address the challenge of enabling advanced search functionality across diverse communication formats.

At step 530, the process 500 may generate an index that organizes archived data objects based on the extracted metadata. The index may support efficient querying, filtering, and retrieval operations, enabling users to locate communications based on various criteria, such as date ranges, sender roles, and/or keywords. For example, an archived email with enriched metadata indicating a “confidential” classification may be retrieved instantly by filtering the index for confidentiality tags. According to some aspects, the index may incorporate hierarchical tagging structures, linking related data objects like email threads, meeting invitations, and/or shared documents. Thereby, step 530 may provide a technical solution to the inefficiencies in conventional search systems, ensuring rapid and precise access to stored communications.

At step 540, the process 500 may establish a linkage (e.g., an immutable linkage) between the index and the archived data objects. The linkage may ensure that any modifications to the index, such as updates to enriched metadata fields, do not affect the original immutable data objects stored in the WORM store. According to some aspects, the linkage mechanism may use unique identifiers or hash values associated with each data object. For example, if organizational directories update a role associated with a recipient of an email, the index may be dynamically updated to reflect the change, while the immutable archived email remains unaffected. This decoupling of the index and the original data object provides flexibility for metadata management while preserving compliance with immutability requirements.

At step 550, the process 500 may validate the generated index to confirm its accuracy and consistency with the archived data objects. According to some aspects, one or more optimization algorithms may be applied to enhance performance of the index during search operations. For example, the index may be optimized by prioritizing frequently queried fields such as keywords or sender information, enabling faster retrieval of high-priority data. Moreover, the validation may ensure that the index correctly reflects the enriched metadata for archived communications, providing a reliable foundation for compliance audits, e-discovery requests, and operational analytics.

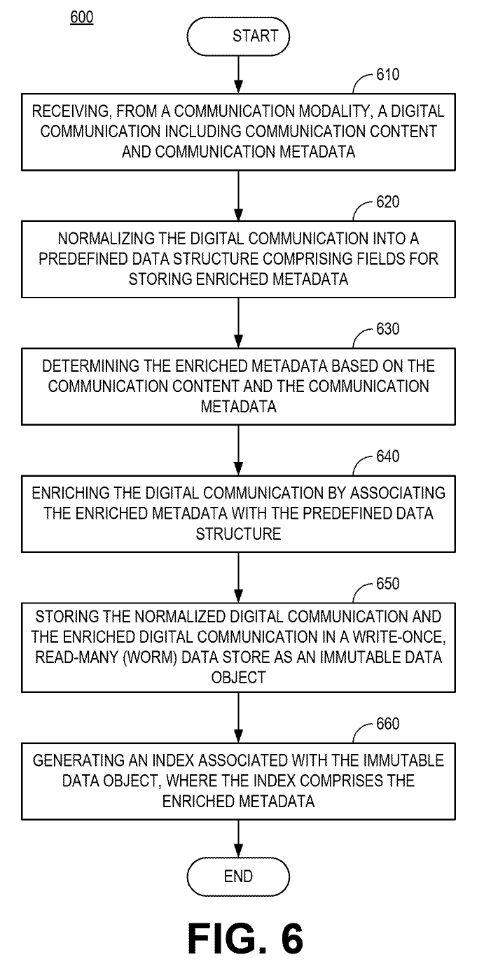

According to some aspects, FIG. 6 illustrates a process 600 for managing digital communications by normalizing, enriching, storing, and/or indexing them for improved compliance, searchability, and analytics. The process 600 may address key technical challenges associated with handling diverse communication formats, ensuring data integrity, and/or meeting stringent regulatory requirements. By leveraging predefined data structures, metadata enrichment techniques, immutable storage mechanisms, and advanced indexing methods, the process 600 may provide a robust framework for managing large volumes of digital communications. The steps of process 600 may outline how digital communications are received, transformed, and archived while maintaining their usability and integrity, enabling organizations to efficiently store, retrieve, and analyze critical communication data in a secure and compliant manner.

At step 610, the process 600 may receive, from a communication modality, a digital communication comprising communication content and communication metadata. The digital communication may be in the form of an email, text message, voice recording, or video call, and may include communication content and metadata. Communication content may include the actual data or message body, while metadata may provide contextual information such as sender and recipient information, timestamps, subject lines, and the communication modality itself (e.g., email, voice, or video). The process 600 may interface with various communication modalities via application programming interfaces (APIs), webhook integrations, or other data retrieval methods. These integrations may ensure that the digital communication is captured in real-time or near real-time, without interrupting the communication flow.

For example, an email message may be captured with its sender, recipient, timestamp, subject, and content. For a text message, the process 600 may capture metadata such as the sender’s phone number, the message body, and the timestamp of the message. Thereby process 600 may address the problem of managing heterogeneous communication formats by providing a uniform method for receiving and processing digital communications across multiple modalities. The process 600 may handle large volumes of communications in real-time by employing scalable systems or cloud-based resources. By accommodating a variety of communication modalities and formats, the process 600 may support organizations facing the challenge of managing diverse types of digital communications without manual intervention or delays.

At step 620, the process 600 may normalize the digital communication into a predefined data structure comprising fields for storing enriched metadata. Moreover, by converting disparate data formats and metadata into a standardized structure, the process 600 may ensure that data from different communication modalities can be processed consistently. For example, an email’s content and metadata may be transformed into a uniform format that includes fields for sender name, recipient identifiers, timestamp, subject line, and message body. Similarly, text messages, which may have different fields or formatting, may be normalized to conform to this predefined structure. This transformation may eliminate discrepancies between data types, such as different timestamp formats (local vs. UTC time) or varied encoding schemes (UTF-8 vs. ASCII), and may enable a more efficient subsequent processing workflow.

The predefined data structure may include additional fields for enriched metadata, which may be populated during later steps of process 600. For example, normalized fields may include space for organizational roles, content classification, and retention flags. The normalized fields may thereby standardize the data and provide placeholders for enriched metadata, addressing technical challenges like inconsistent encoding schemes, missing data, or varying file formats. Moreover, by standardizing the structure of incoming communications, the process 600 may provide a consistent framework for all types of communication, enabling the system to process, enrich, and index communications from disparate sources in a unified manner.

At step 630, the process 600 may determine the enriched metadata based on the communication content and the communication metadata. According to some aspects, the enriched metadata may be sourced from internal systems, such as organizational directories, or external sources such as geographic databases or third-party APIs. For example, if the communication is an email, the process 600 may query an internal directory to retrieve the sender’s role or department and append that information to the metadata. For a text message, the process 600 may pull geolocation data based on the phone number’s area code or IP address. Moreover, the process 600 may use Optical Character Recognition (OCR) on any image-based attachments (e.g., scanned documents or PDFs) to extract and make the text searchable, further enriching the metadata associated with the communication.

According to some aspects, metadata enrichment may include identifying whether the sender is internal or external to the organization, detecting the language of the communication, and/or associating any custom attributes like confidentiality flags, priority levels, or retention policies. These enrichments may be valuable for compliance, as they ensure that all communications are categorized and tagged appropriately, providing transparency and traceability for regulatory audits. Moreover, step 530 may be performed dynamically, allowing the enriched metadata to reflect real-time changes in external sources or organizational structures. For example, if an employee’s organizational role changes, the process 600 may automatically update the enriched metadata to reflect this change without affecting the original content of the communication. This adaptability may ensure that the metadata remains relevant and accurate throughout the lifecycle of the communication data object, enhancing its value for compliance, searchability, and analytics.

At step 640, the process 600 may enrich the digital communication by associating the enriched metadata with the predefined data structure. The enriched metadata, which may provide deeper contextual understanding of the communication, may be integrated into the predefined structure, ensuring that it is accessible and usable in future stages of processing, such as storage and indexing. For example, if an email is enriched with organizational metadata (e.g., sender’s department, role, etc.), this information may be appended to the normalized email’s data structure in the relevant fields. If a document attached to the email is scanned and processed by OCR, the extracted text may be incorporated into the metadata associated with the communication. According to some aspects, the enriched metadata may include flags for legal retention, confidentiality, and/or compliance with certain regulations, ensuring that the communication is properly categorized according to organizational and regulatory standards.

By associating this enriched metadata with the normalized communication data, the process 600 may ensure that all relevant contextual information is maintained in a structured format. According to some aspects, the integration may support more accurate and efficient indexing, as the enriched metadata may provide additional attributes for categorization and search filtering. This addresses the technical challenge of categorizing diverse data types, ensuring that all communications are treated uniformly, regardless of their original format or source. Moreover, process 600 may maintain the integrity of the communication’s content while still enabling flexibility in metadata management. For example, if updates are made to organizational roles or external directories, the enriched metadata may be adjusted without modifying the immutable content of the communication. This decoupling of content and metadata allows for easier management of updates and corrections to metadata, ensuring compliance without compromising the original data.

At step 650, the process 600 may store the normalized digital communication and the enriched digital communication in a WORM data store as an immutable data object. The WORM data store may ensure that once the communication is archived, it cannot be modified or deleted, addressing regulatory requirements that demand the secure, unalterable storage of sensitive communications. In one aspect, for example, an email with enriched metadata (e.g., sender/recipient roles, timestamps, confidentiality tags) may be archived in the WORM data store. This archiving process may include storing the communication in a format that guarantees its integrity over time. The process 600 may also use cryptographic hashing to verify the authenticity of the data object, ensuring that it has not been tampered with or altered after archiving. This approach addresses the technical challenge of maintaining compliance with regulations like the SEC or GDPR, which mandate that communications be stored in an immutable and auditable manner.

Moreover, the WORM data store may be optimized for high-read operations, allowing archived communications to be accessed efficiently without compromising their immutability. The combination of high performance and secure, immutable storage addresses operational needs by ensuring that archived communications remain accessible while remaining compliant with regulatory standards. Process 600 may also facilitate quick retrieval of communications during audits or discovery requests, as the architecture of the data store may support the retrieval of vast amounts of data while ensuring data integrity.

At step 660, the process 600 may generate an index associated with the immutable data object, where the index comprises the enriched metadata. According to some aspects, the index may incorporate the enriched metadata, enabling users to search for archived communications based on various criteria such as keywords, timestamps, sender/recipient information, or content classifications. For example, an archived video call may be indexed by participant names, call duration, and/or keywords from a transcript, making it searchable based on the enriched metadata fields. Moreover, an email may be indexed by its subject line, sender and recipient information, and/or any relevant attachments. The index may also allow for hierarchical tagging, enabling users to search across related communications, such as email threads or corresponding calendar events, and retrieve them together.

Thereby, process 600 may provide a technical solution to the challenge of searching and retrieving large volumes of archived data. Traditional search systems may struggle with the complexity of heterogeneous data formats and metadata fields, but the enriched index created in step 660 may enable efficient querying and retrieval, addressing both the operational need for rapid access to relevant communications and the compliance need for thorough, auditable retrieval of data when required for legal or regulatory purposes. Moreover, the process 600 may dynamically update the index to reflect changes in metadata or organizational directories, ensuring that the search index remains accurate and relevant. For example, if a user’s role changes within the organization, the process 600 may update the index to reflect this change, while the original immutable communication may remain unchanged. This flexibility may ensure that the system can continue to provide accurate and actionable data over time without compromising the integrity of the stored communications.

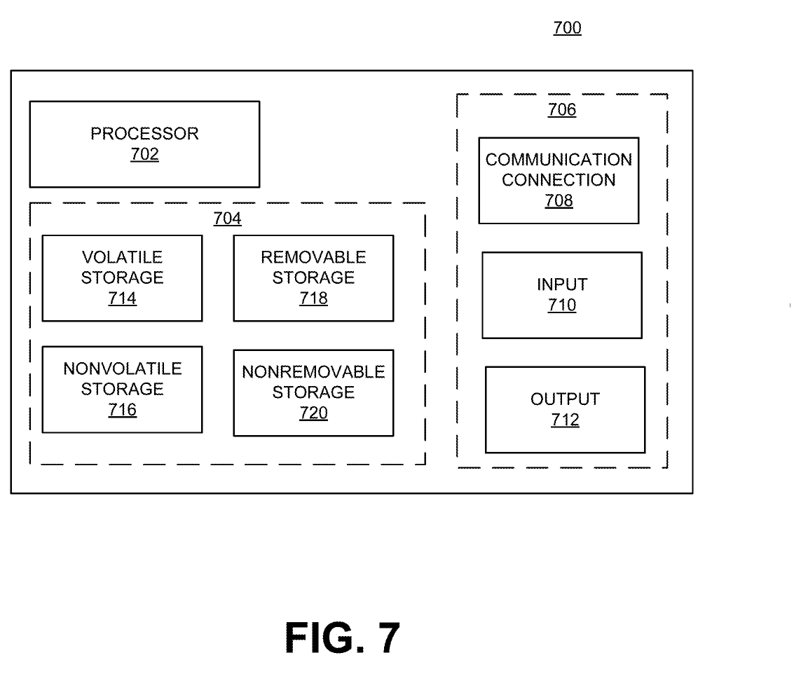

FIG. 7 is a block diagram of a computing device 700 that may be connected to or comprise a component of system 100 or environment 200. Computing device 700 may comprise hardware or a combination of hardware and software. The functionality to normalize, enrich, and/or store communications may reside in one or a combination of computing devices 700. Computing device 700 depicted in FIG. 7 may represent or perform functionality of an appropriate computing device 700, or a combination of computing devices 700, such as, for example, a component or various components of a digital communication management system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 7 is exemplary and not intended to imply a limitation to a specific example or configuration. Thus, computing device 700 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 700 may comprise a processor 702 and a memory 704 coupled to processor 702. Memory 704 may contain executable instructions that, when executed by processor 702, cause processor 702 to effectuate operations associated with digital communication management. As evident from the description herein, computing device 700 is not to be construed as software per se.

In addition to processor 702 and memory 704, computing device 700 may include an input/output system 706. Processor 702, memory 704, and input/output system 706 may be coupled together (coupling not shown in FIG. 7) to allow communications between them. Each portion of computing device 700 may comprise circuitry for performing functions associated with each respective portion. Thus, each portion may comprise hardware, or a combination of hardware and software. Accordingly, each portion of computing device 700 is not to be construed as software per se. Input/output system 706 may be capable of receiving or providing information from or to a communications device or other network entities configured for digital communication management. For example, input/output system 706 may include a wireless communication (e.g., 3G/4G/5G/GPS) card. Input/output system 706 may be capable of receiving or sending video information, audio information, control information, image information, data, or any combination thereof. Input/output system 706 may be capable of transferring information with computing device 700. In various configurations, input/output system 706 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 706 may comprise a Wi-Fi finder, a two-way GPS chipset or equivalent, or the like, or a combination thereof.

Input/output system 706 of computing device 700 also may contain a communication connection 708 that allows computing device 700 to communicate with other devices, network entities, or the like. Communication connection 708 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 706 also may include an input device 710 such as keyboard, mouse, pen, voice input device, or touch input device. Input/output system 706 may also include an output device 712, such as a display, speakers, or a printer.

Processor 702 may be capable of performing functions associated with digital communication management, such as functions for normalizing, enriching, and/or storing communications, as described herein. For example, processor 702 may be capable of, in conjunction with any other portion of computing device 700, facilitating various functions for the operation of a digital communication management system, as described herein.

Memory 704 of computing device 700 may comprise a storage medium having a concrete, tangible, physical structure. As is known, a signal does not have a concrete, tangible, physical structure. Memory 704, as well as any computer-readable storage medium described herein, is not to be construed as a signal. Memory 704, as well as any computer-readable storage medium described herein, is not to be construed as a transient signal. Memory 704, as well as any computer-readable storage medium described herein, is not to be construed as a propagating signal. Memory 704, as well as any computer-readable storage medium described herein, is to be construed as an article of manufacture.

Memory 704 may store any information utilized in conjunction with digital communication management. Depending upon the exact configuration or type of processor, memory 704 may include a volatile storage 714 (such as some types of RAM), a nonvolatile storage 716 (such as ROM, flash memory), or a combination thereof. Memory 704 may include additional storage (e.g., a removable storage 718 or a non-removable storage 720) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 700. Memory 704 may comprise executable instructions that, when executed by processor 702, cause processor 702 to effectuate operations associated with digital communication management.

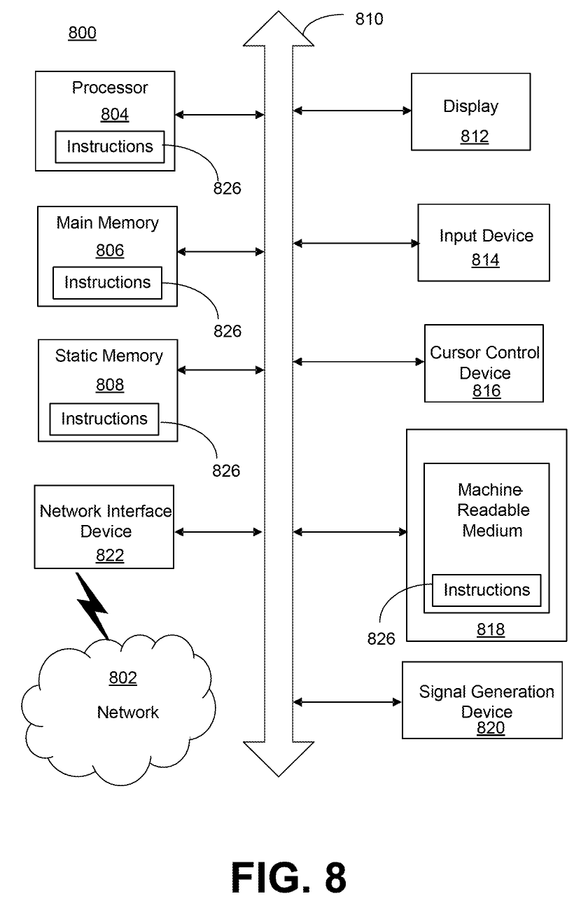

FIG. 8 depicts an exemplary diagrammatic representation of a machine in the form of a computer system 800 within which a set of instructions, when executed, may cause the machine to perform any one or more of the methods described above. One or more instances of the machine can operate, for example, as processor 702, computing environment 203, computing devices 206, data store 210, data store 227, and other devices of FIGS. 1-7. In some examples, the machine may be connected (e.g., using a network 802) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 800 may include a processor (or controller) 804 (e.g., a central processing unit (CPU)), a graphics processing unit (GPU, or both), a main memory 806 and a static memory 808, which communicate with each other via a bus 810. The computer system 800 may further include a display unit 812 (e.g., a liquid crystal display (LCD), a flat panel, or a solid-state display). Computer system 800 may include an input device 814 (e.g., a keyboard), a cursor control device 816 (e.g., a mouse), a disk drive unit 818, a signal generation device 820 (e.g., a speaker or remote control) and a network interface device 822. In distributed environments, the examples described in the subject disclosure can be adapted to utilize multiple display units 812 controlled by two or more computer systems 800. In this configuration, presentations described by the subject disclosure may in part be shown in a first of display units 812, while the remaining portion is presented in a second of display units 812.

The disk drive unit 818 may include a tangible computer-readable storage medium on which is stored one or more sets of instructions (e.g., instructions 826) embodying any one or more of the methods or functions described herein, including those methods illustrated above. Instructions 826 may also reside, completely or at least partially, within main memory 806, static memory 808, or within processor 804 during execution thereof by the computer system 800. Main memory 806 and processor 804 also may constitute tangible computer-readable storage media.

While examples of a system for digital communication management have been described in connection with various computing devices/processors, the underlying concepts may be applied to any computing device, processor, or system capable of facilitating digital communication management. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for digital communication management. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with digital communication management as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing digital communication management as described herein. When implemented on a general-purpose processor, the program code combines with the processor to provide a unique device that operates to invoke the functionality of a digital communication management system.

While the disclosed systems have been described in connection with the various examples of the various figures, it is to be understood that other similar implementations may be used, or modifications and additions may be made to the described examples of a digital communication management system without deviating therefrom. For example, one skilled in the art will recognize that a digital communication management system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure – normalizing, enriching, and/or storing communications – as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

Clause 1. A method performed by one or more networked computing devices, the method comprising: receiving, from a communication modality, a digital communication comprising communication content and communication metadata; normalizing the digital communication into a predefined data structure comprising fields for storing enriched metadata; determining the enriched metadata based on the communication content and the communication metadata; enriching the digital communication by associating the enriched metadata with the predefined data structure; storing the normalized digital communication and the enriched digital communication in a write-once, read-many (WORM) data store as an immutable data object; and generating an index associated with the immutable data object, wherein the index comprises the enriched metadata.

Clause 2. The method of clause 1 or any other clause herein, wherein the communication modality comprises at least one of email, text messages, voice recordings, video calls, or collaborative communication platforms.

Clause 3. The method of clause 1 or any other clause herein, wherein the communication metadata comprises sender information, recipient information, timestamps, subject lines, or attachment details.

Clause 4. The method of clause 1 or any other clause herein, further comprising: identifying a source of the communication modality; and adding, based on the source of the communication modality, a source identifier to the enriched metadata.

Clause 5. The method of clause 1 or any other clause herein, wherein normalizing the digital communication comprises standardizing a format associated with the communication content and the communication metadata to correspond to the predefined data structure.

Clause 6. The method of clause 1 or any other clause herein, wherein the communication metadata comprises a plurality of metadata entries and normalizing the digital communication comprises comprising removing one or more duplicate metadata entries of the plurality of metadata entries.

Clause 7. The method of clause 1 or any other clause herein, wherein determining the enriched metadata comprises determining, based directory information, whether a sender associated with the digital communication is internal or external to an organization.

Clause 8. The method of clause 7 or any other clause herein, wherein determining the enriched metadata further comprises determining, based on the directory information, an organizational role or group associated with the sender.

Clause 9. The method of clause 1 or any other clause herein, wherein determining the enriched metadata comprises determining a language associated with the communication content.

Clause 10. The method of clause 1 or any other clause herein, further comprising determining searchable text associated with the digital communication by performing optical character recognition (OCR) on non-searchable content associated with the digital communication.

Clause 11. The method of clause 1 or any other clause herein, wherein determining the enriched metadata comprises one or more of a priority level, a confidentiality flag, or a retention tag.

Clause 12. The method of clause 1 or any other clause herein, further comprising determining one or more keyword tags based on natural language processing of the communication content, wherein the enriched metadata comprises the one or more keyword tags.

Clause 13. The method of clause 1 or any other clause herein, wherein the enriched metadata comprises one or more external compliance requirements.

Clause 14. The method of clause 1 or any other clause herein, wherein the immutable data object is associated with a storage time, an access time, and a retrieval time.

Clause 15. The method of clause 1 or any other clause herein, wherein the WORM data store comprises a distributed blockchain ledger.

Clause 16. The method of clause 1 or any other clause herein, further comprising verifying the immutable data object by comparing a hash of the stored immutable data object to a previously generated hash.

Clause 17. The method of clause 1 or any other clause herein, wherein generating the index comprises tagging the immutable data object with a plurality of enriched metadata fields for advanced filtering and search functionality.

Clause 18. The method of clause 1 or any other clause herein, further comprising updating the index associated with the immutable data object, wherein original content associated with the digital communication is maintained.

Clause 19. One or more computing devices, comprising one or more processors, configured to: receive, from a communication modality, a digital communication comprising communication content and communication metadata; normalize the digital communication into a predefined data structure comprising fields for storing enriched metadata; determine the enriched metadata based on the communication content and the communication metadata; enrich the digital communication by associating the enriched metadata with the predefined data structure; store the normalized digital communication and the enriched digital communication in a write-once, read-many (WORM) data store as an immutable data object; and generate an index associated with the immutable data object, wherein the index comprises the enriched metadata.

Clause 20. A system comprising: one or more processors; and a memory coupled with the one or more processors, the memory storing executable instructions that when executed by the one or more processors cause the one or more processors to effectuate operations comprising: receiving, from a communication modality, a digital communication comprising communication content and communication metadata; normalizing the digital communication into a predefined data structure comprising fields for storing enriched metadata; determining the enriched metadata based on the communication content and the communication metadata; enriching the digital communication by associating the enriched metadata with the predefined data structure; storing the normalized digital communication and the enriched digital communication in a write-once, read-many (WORM) data store as an immutable data object; and generating an index associated with the immutable data object, wherein the index comprises the enriched metadata.

This written description uses examples to enable any person skilled in the art to practice the claimed subject matter, including making and using any devices or systems and performing any incorporated methods. Other variations of the examples are contemplated herein.

What is claimed is:

1. A method performed by one or more networked computing devices, the method comprising:
receiving, from a communication modality, a digital communication comprising communication content and communication metadata;
normalizing the digital communication into a predefined data structure comprising fields for storing enriched metadata;
determining the enriched metadata based on the communication content and the communication metadata;
enriching the digital communication by associating the enriched metadata with the predefined data structure;
storing the normalized digital communication and the enriched digital communication in a write-once, read-many (WORM) data store as an immutable data object; and
generating an index associated with the immutable data object, wherein the index comprises the enriched metadata.

2. The method of claim 1, wherein the communication modality comprises at least one of email, text messages, voice recordings, video calls, or collaborative communication platforms.

3. The method of claim 1, wherein the communication metadata comprises sender information, recipient information, timestamps, subject lines, or attachment details.

4. The method of claim 1, further comprising:
identifying a source of the communication modality; and
adding, based on the source of the communication modality, a source identifier to the enriched metadata.

5. The method of claim 1, wherein normalizing the digital communication comprises standardizing a format associated with the communication content and the communication metadata to correspond to the predefined data structure.

6. The method of claim 1, wherein the communication metadata comprises a plurality of metadata entries and normalizing the digital communication comprises comprising removing one or more duplicate metadata entries of the plurality of metadata entries.

7. The method of claim 1, wherein determining the enriched metadata comprises determining, based directory information, whether a sender associated with the digital communication is internal or external to an organization.

8. The method of claim 7, wherein determining the enriched metadata further comprises determining, based on the directory information, an organizational role or group associated with the sender.

9. The method of claim 1, wherein determining the enriched metadata comprises determining a language associated with the communication content.

10. The method of claim 1, further comprising determining searchable text associated with the digital communication by performing optical character recognition (OCR) on non-searchable content associated with the digital communication.

11. The method of claim 1, wherein determining the enriched metadata comprises one or more of a priority level, a confidentiality flag, or a retention tag.

12. The method of claim 1, further comprising determining one or more keyword tags based on natural language processing of the communication content, wherein the enriched metadata comprises the one or more keyword tags.

13. The method of claim 1, wherein the enriched metadata comprises one or more external compliance requirements.

14. The method of claim 1, wherein the immutable data object is associated with a storage time, an access time, and a retrieval time.

15. The method of claim 1, wherein the WORM data store comprises a distributed blockchain ledger.

16. The method of claim 1, further comprising verifying the immutable data object by comparing a hash of the stored immutable data object to a previously generated hash.

17. The method of claim 1, wherein generating the index comprises tagging the immutable data object with a plurality of enriched metadata fields for advanced filtering and search functionality.

18. The method of claim 1, further comprising updating the index associated with the immutable data object, wherein original content associated with the digital communication is maintained.

19. One or more computing devices, comprising one or more processors, configured to:
receive, from a communication modality, a digital communication comprising communication content and communication metadata;
normalize the digital communication into a predefined data structure comprising fields for storing enriched metadata;
determine the enriched metadata based on the communication content and the communication metadata;
enrich the digital communication by associating the enriched metadata with the predefined data structure;
store the normalized digital communication and the enriched digital communication in a write-once, read-many (WORM) data store as an immutable data object; and
generate an index associated with the immutable data object, wherein the index comprises the enriched metadata.

20. A system comprising:
one or more processors; and
a memory coupled with the one or more processors, the memory storing executable instructions that when executed by the one or more processors cause the one or more processors to effectuate operations comprising:
receiving, from a communication modality, a digital communication comprising communication content and communication metadata;
normalizing the digital communication into a predefined data structure comprising fields for storing enriched metadata;
determining the enriched metadata based on the communication content and the communication metadata;
enriching the digital communication by associating the enriched metadata with the predefined data structure;
storing the normalized digital communication and the enriched digital communication in a write-once, read-many (WORM) data store as an immutable data object; and
generating an index associated with the immutable data object, wherein the index comprises the enriched metadata.
